(19) United States
(12) Patent Application Publication
(10) Pub. No.: US 2009/0152237 A1
(43) Pub. Date: Jun. 18, 2009

(54) Ceramic-Copper Foil Bonding Method

(75) Inventors: Wen-Chung Chiang, Banciao City (TW); Keng-Chung Wu, Banciao City (TW); Jun-Jae Wu, Banciao City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: High Conduction Scientific Co., Ltd., Lujhu Township (TW)

(21) Appl. No.: 12/336,239

(22) Filed: Dec. 16, 2008

(30) Foreign Application Priority Data
Dec. 18, 2007 (TW) 096148408

(51) Int. Cl. C23F 1/00; B32B 37/00

(52) U.S. Cl. 216/33; 156/60

(57) ABSTRACT

A ceramic-copper foil bonding method includes wet-oxidizing a copper foil such that a surface of the copper foil is oxidized to a copper oxide layer, contacting the copper oxide layer with a surface of a ceramic substrate, and bonding the copper oxide layer of the copper foil to the surface of the ceramic substrate by heat treatment. Preferably, a protective layer is provided on an opposite surface of the copper foil so that the opposite surface is not oxidized during wet-oxidizing the copper foil.

### CROSS-REFERENCE TO RELATED APPLICATION

This application claims priority to Taiwanese Application No. 096148408, filed Dec. 18, 2007, the disclosure of which is herein incorporated by reference.

### BACKGROUND OF THE INVENTION

1. Field of the Invention

This invention relates to a method of bonding a copper foil to a ceramic substrate, more particularly to a bonding method including oxidation of a copper foil to form a copper oxide layer that is subsequently bonded to a ceramic substrate through heat treatment.

2. Description of the Related Art

Direct bonding copper (DBC) or direct copper bonding (DCB) is a conventional method of bonding a copper foil to a ceramic substrate. In the conventional method, a copper foil is oxidized such that a surface of the copper foil is oxidized to a copper oxide layer. The copper foil is disposed on a surface of a ceramic substrate such that the copper oxide layer is in contact with the surface of the ceramic substrate. The copper foil and the ceramic substrate are heated together to a temperature that is lower than 1083° C. (the melting point of copper) and higher than 1063° C. (the eutectic temperature of the copper-copper oxide eutectic). Therefore, the copper foil is bonded to the surface of the ceramic substrate.

Conventionally, the surface of the copper foil is oxidized to the copper oxide layer by pre-heating the copper foil before the copper foil and the ceramic substrate are heated together. However, when the copper foil is pre-heated, two copper oxide layers are formed on two opposite surfaces of the copper foil.

Referring to FIG. 1, a first copper foil 91 has two copper oxide layers 911 and is disposed on a first surface of a ceramic substrate 93 such that one of the copper oxide layers 911 is in contact with the first surface of the ceramic substrate 93. A second copper foil 92 has two copper oxide layers 921 and is disposed between the ceramic substrate 93 and a saggar 94 that is made from a ceramic material and that is used for holding together the first copper foil 91, the ceramic substrate 93, and the second copper foil 92. The copper oxide layers 921 of the second copper foil 92 are respectively in contact with a second surface of the ceramic substrate 93 and a surface of the saggar 94. If the first copper foil 91, the ceramic substrate 93, and the second copper foil 92 are heated together with the saggar 94, the first and second copper foils 91,92 will be respectively bonded to the first and second surfaces of the ceramic substrate 93, and the second copper foil 92 will be undesirably bonded to the surface of the saggar 94. Therefore, if two sides of a ceramic substrate are to be bonded respectively to two copper foils, each of which has two opposite copper oxide layers, an undesired bond will be formed between one of the copper foils and a saggar.

In order to avoid the aforesaid problem, the prior art suggests a method of bonding two copper foils to two surfaces of a ceramic substrate as illustrated in FIG. 2. A first copper foil 95 that has a first copper oxide layer 951 and a second copper oxide layer 952 is disposed on a first surface of a ceramic substrate 96 that is disposed on a surface of a saggar 97. The first copper oxide layer 951 of the first copper foil 95 is in contact with the first surface of the ceramic substrate 96. When the first copper foil 95 and the ceramic substrate 96 are heated together, the first copper foil 95 is bonded to the first surface of the ceramic substrate 96. The second copper oxide layer 952 of the first copper foil 95 is subsequently reduced to copper. Afterward, the first copper foil 95 and the ceramic substrate 96 are inverted such that the saggar 97 is in contact with the surface of the first copper foil 95 where the second copper oxide layer has been reduced to copper. Thereafter, a second copper foil 98 that has a first copper oxide layer 981 and a second copper oxide layer 982 is disposed on a second surface of the ceramic substrate 96. The first copper oxide layer 981 of the second copper foil 98 is in contact with the second surface of the ceramic substrate 96. When the second copper foil 98, the ceramic substrate 96, and the first copper foil 95 are heated together, the second copper foil 98 is bonded to the second surface of the ceramic substrate 96. The second copper oxide layer 982 of the second copper foil 98 is subsequently reduced to copper. As such, none of the first and second copper foils 95,98 is bonded to the surface of the saggar 97. However, the conventional method requires several heat treatment steps and is thus complicated and energy consuming.

### SUMMARY OF THE INVENTION

Therefore, the object of the present invention is to provide a ceramic-copper foil bonding method that can eliminate the aforesaid drawbacks of the prior art and that employs wet-oxidation to oxidize a copper foil.

According to one aspect of this invention, a ceramic-copper foil bonding method comprises wet-oxidizing a first copper foil such that a first surface of the first copper foil is oxidized to a copper oxide layer, contacting the copper oxide layer with a first surface of a ceramic substrate, and bonding the copper oxide layer of the first copper foil to the first surface of the ceramic substrate by heat treatment.

According to another aspect of this invention, a ceramic-copper foil bonding method comprises: providing first and second copper foils, each of which has a first surface and a second surface opposite to the first surface; wet-oxidizing the first and second copper foils such that the first surface of each of the first and second copper foils is oxidized to a copper oxide layer and the second surface of each of the first and second copper foils is not oxidized; contacting the copper oxide layers of the first and second copper foils with opposite first and second surfaces of a ceramic substrate, respectively; and heating together the first copper foil, the second copper foil, and the ceramic substrate, thereby bonding the same together.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view to illustrate a problem that might occur if a ceramic substrate is bonded to two copper foils which are oxidized through a method employed in the art;

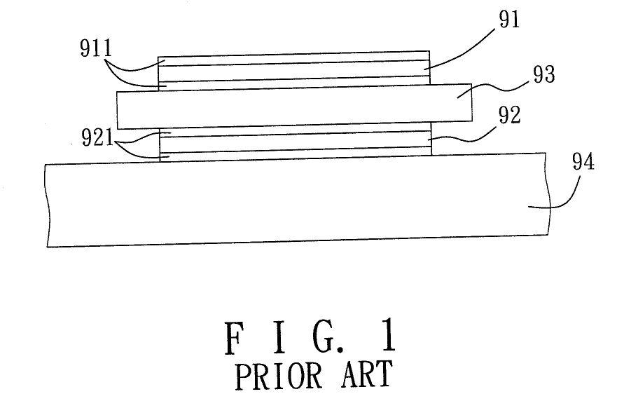

FIG. 2 is a schematic flow chart to illustrate a conventional method of bonding two copper foils to a ceramic substrate;

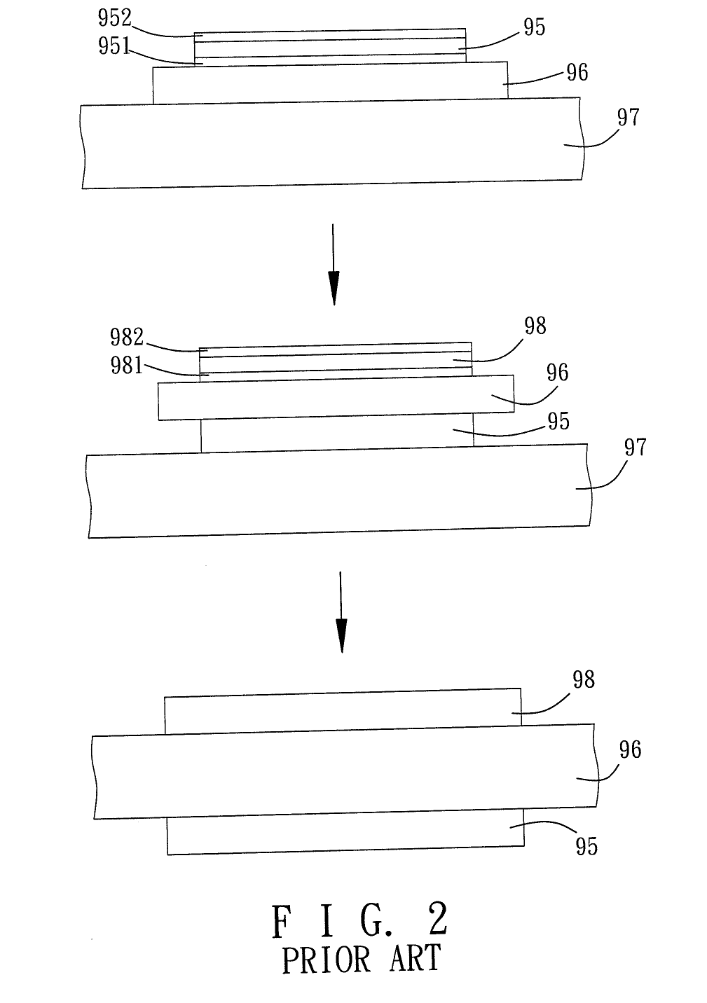

FIG. 3 is a schematic flow chart to illustrate a ceramic-copper foil bonding method conducted in Example 1 of this invention; and

FIG. 4 is a schematic flow chart to illustrate another ceramic-copper foil bonding method conducted in Example 2 of this invention.

### DETAILED DESCRIPTION OF THE PREFERRED EMBODIMENTS

According to the present invention, a ceramic-copper foil bonding method includes wet-oxidizing a first copper foil such that a first surface of the first copper foil is oxidized to a copper oxide layer, contacting the copper oxide layer with a first surface of a ceramic substrate, and bonding the copper oxide layer of the first copper foil to the first surface of the ceramic substrate by heat treatment.

Preferably, the ceramic-copper foil bonding method further includes providing a protective layer on a second surface of the first copper foil, which is opposite to the first surface of the first copper foil, before wet-oxidizing the first copper foil such that the second surface of the first copper foil is not oxidized during wet-oxidizing the first copper foil. The protective layer may be a tape attached to the second surface of the first copper foil. The tape may be made from a material selected from the group consisting of polyvinyl chloride, polyethylene terephthalate, and polyimide.

In an embodiment, the method further includes roughening the first copper foil before wet-oxidizing the first copper foil. Preferably, the first copper foil is roughened in a roughening solution including hydrogen peroxide, sulfuric acid, and a stabilizer. The stabilizer is one selected from the group consisting of ethylamine and acetamide. The roughening solution includes sulfuric acid in a concentration that ranges from 100 to 250 grams per liter of the roughening solution, hydrogen peroxide in a concentration that ranges from 20 to 40 grams per liter of the roughening solution, and the stabilizer in a concentration that ranges from 0.5 to 15 grams per liter of the roughening solution. The roughening solution is kept at a temperature that ranges from 25° C. to 60° C. The first copper foil is roughened in the roughening solution for 1 to 5 minutes.

The first copper foil is wet-oxidized in an oxidizing solution including an oxidizing agent selected from the group consisting of potassium persulfate, sodium phosphate, and sodium chlorite. The oxidizing solution includes the oxidizing agent in a concentration that ranges from 2 to 60 grams per liter of the oxidizing solution. In an embodiment, the oxidizing solution further includes sodium hydroxide. The oxidizing solution is kept at a temperature that ranges from 25° C. to 80° C. The first copper foil is wet-oxidized in the oxidizing solution for 10 seconds to 10 minutes.

In another embodiment, the method further includes forming an oxygen-isolation layer on a surface of the copper oxide layer of the first copper foil to prevent further oxidation before contacting the copper oxide layer with the first surface of the ceramic substrate. To this end, the copper oxide layer of the first copper foil is disposed in an anti-oxidizing solution including an antioxidant for forming the oxygen-isolation layer. The antioxidant is made from a material selected from the group consisting of benzotriazole, triazole, imidazole, and tetrazole. The anti-oxidizing solution is kept at a temperature that ranges from 25° C. to 60° C. The copper oxide layer of the first copper foil is disposed in the anti-oxidizing solution for 10 seconds to 5 minutes.

In still another embodiment, the method further includes: wet-oxidizing a second copper foil such that a first surface of the second copper foil is oxidized to a copper oxide layer, and a second surface of the second copper foil, which is opposite to the first surface of the second copper foil, is not oxidized; contacting the copper oxide layer of the second copper foil with a second surface of the ceramic substrate, which is opposite to the first surface of the ceramic substrate, before bonding the copper oxide layer of the first copper foil to the first surface of the ceramic substrate; and bonding the copper oxide layer of the second copper foil to the second surface of the ceramic substrate simultaneously with the bonding of the copper oxide layer of the first copper foil to the first surface of the ceramic substrate by heat treatment.

### Example 1

### Roughening

30 g hydrogen peroxide, 150 g sulfuric acid, and 10 g ethylamine were added to 1 L de-ionized water so as to form a roughening solution. Subsequently, the roughening solution was heated to about 50° C.

A first copper foil was cleaned. A tape was attached to one surface of the first copper foil as a protective layer, while another surface of the first copper foil was kept exposed. When the first copper foil was soaked in the roughening solution for approximately 3 minutes, the exposed surface opposite to the tape was corroded and formed into a rough layer. The chemical reaction for roughening the first copper foil is as follows:

Cu+H₂O₂+H₂SO₄→CuSO₄+2H₂O

The first copper foil was removed from the roughening solution and subsequently rinsed with de-ionized water.

### Wet-Oxidizing

40 g sodium chlorite and 30 g sodium hydroxide were added to 1 L de-ionized water so as to form an oxidizing solution. The oxidizing solution was heated to about 77° C. When the first copper foil was soaked in the oxidizing solution for approximately 5 minutes, the rough layer of the first copper foil was oxidized to a copper oxide layer. The chemical reaction for wet-oxidizing the first copper foil is as follows:

2Cu+NaClO₂+2H₂O→2Cu(OH)₂+NaCl

2Cu(OH)₂→2CuO+2H₂O

The first copper foil having the copper oxide layer was removed from the oxidizing solution, rinsed with de-ionized water, and dried in sequence. When the first copper foil was dry, the tape was detached from the first copper foil. The first copper foil thus had one surface formed with the copper oxide layer, and another surface of the first copper foil to which the tape was attached was not oxidized during wet-oxidizing the first copper foil.

### Bonding

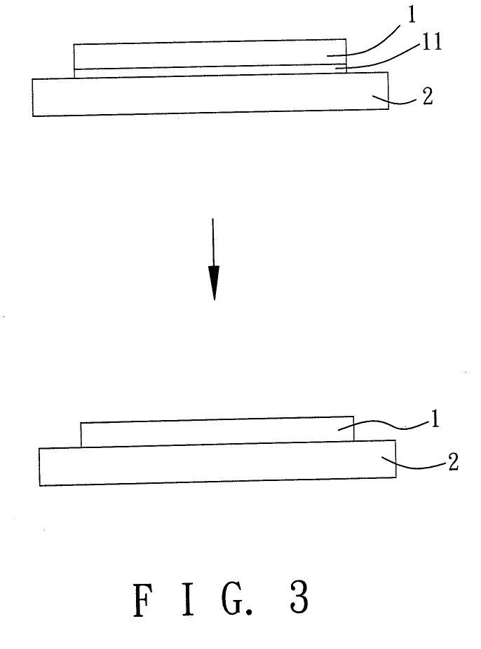

Referring to FIG. 3, the first copper foil 1 was disposed on a first surface of a ceramic substrate 2 made from aluminum oxide such that the copper oxide layer 11 of the first copper foil 1 was in contact with the first surface of the ceramic substrate 2. The first copper foil 1 and the ceramic substrate 2 were heated to about 1070° C. for 20 minutes in an atmosphere having a 20 ppm oxygen level. Thus, the first copper foil 1 was bonded to the first surface of the ceramic substrate 2.

If the bonding step is not to be conducted immediately after the wet-oxidizing step, an oxygen-isolation layer may be formed on a surface of the copper oxide layer of the first copper foil. Therefore, the copper oxide layer of the first copper foil can be isolated from oxygen by virtue of the oxygen-isolation layer so as to prevent the first copper foil from further oxidation that may result in thickening of the copper oxide layer and hence in reducing the bonding strength. To form the oxygen-isolation layer, the first copper foil having the copper oxide layer was soaked in a 10 g/L benzotriazole solution. After about 2 minutes, the first copper foil was removed from the benzotriazole solution and formed with the oxygen-isolation layer.

### Example 2

### Roughening

30 g hydrogen peroxide, 150 g sulfuric acid, and 1 g acetamide were added to 1 L de-ionized water so as to form a roughening solution. Subsequently, the roughening solution was heated to about 50° C.

A first copper foil and a second copper foil were cleaned. Each of the first and second copper foils had opposite first and second surfaces. A tape was attached to the second surface of the first copper foil as a protective layer. The first surface of the first copper foil was exposed to the roughening solution. Another tape was attached to the second surface of the second copper foil as a protective layer. The first surface of the second copper foil was exposed to the roughening solution.

The first and second copper foils were soaked in the roughening solution for approximately 5 minutes. Each of the second surfaces of the first and second copper foils was corroded so as to form a rough layer. The chemical reaction for roughening the first and second copper foils is as follows:

Cu+H₂O₂+H₂SO₄→CuSO₄+2H₂O

The first and second copper foils were removed from the roughening solution and subsequently rinsed with de-ionized water.

### Wet-Oxidizing

10 g potassium persulfate and 50 g sodium hydroxide were added to 1 L de-ionized water in order to form an oxidizing solution. The oxidizing solution was heated to about 60° C. The first and second copper foils were soaked in the oxidizing solution for approximately 7 minutes. Each of the rough layers of the first and second copper foils was oxidized to a copper oxide layer. The chemical reaction for wet-oxidizing the first and second copper foils is as follows:

K₂S₂O₈+2NaOH→K₂SO₄+Na₂SO₄+H₂O+[O]

Cu+2NaOH+[O]→Na₂CuO₂+H₂O

Na₂CuO₂+H₂O→CuO+2NaOH

The first and second copper foils were removed from the oxidizing solution, rinsed with de-ionized water, and dried in sequence. The tapes were respectively detached from the first and second copper foils when the first and second copper foils were dry. The first and second copper foils had the first surfaces thereof oxidized, and the second surfaces thereof were not oxidized.

### Bonding

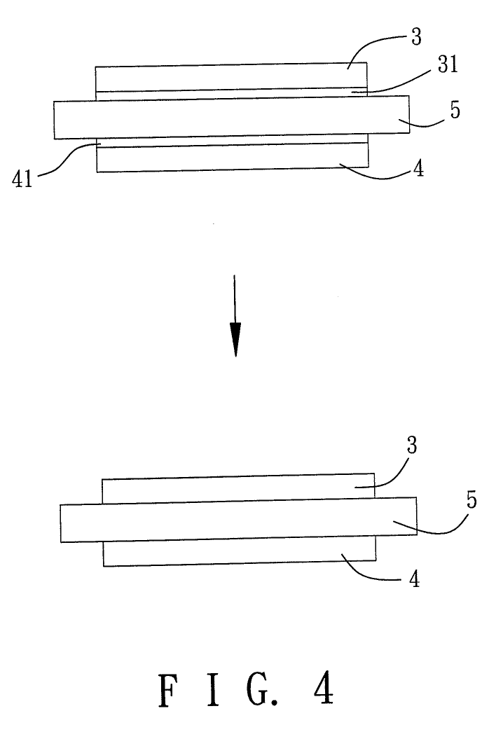

Referring to FIG. 4, the first copper foil 3 having the copper oxide layer 31, and the second copper foil 4 having the copper oxide layer 41 were disposed in contact with a ceramic substrate 5 made from aluminum nitride. The copper oxide layer 31 of the first copper foil 3 was in contact with a first surface of the ceramic substrate 5. The copper oxide layer 41 of the second copper foil 4 was in contact with a second surface of the ceramic substrate 5. The first copper foil 3, the ceramic substrate 5, and the second copper foil 4 were heated to about 1072° C. for 15 minutes in an atmosphere having a 20 ppm oxygen level. Therefore, the first and second copper foils 3,4 were respectively bonded to the first and second surfaces of the ceramic substrate 5.

According to the present invention, two copper foils can be bonded to a ceramic substrate through a single heat treatment step, thereby reducing energy necessary for bonding two copper foils to a ceramic substrate compared to the conventional method. The method is simple and can be performed at a relatively low cost.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A ceramic-copper foil bonding method comprising:
wet-oxidizing a first copper foil such that a first surface of the first copper foil is oxidized to a copper oxide layer;
contacting the copper oxide layer with a first surface of a ceramic substrate; and
bonding the copper oxide layer of the first copper foil to the first surface of the ceramic substrate by heat treatment.

2. The method of claim 1, wherein the first copper foil is wet-oxidized in an oxidizing solution including an oxidizing agent selected from the group consisting of potassium persulfate, sodium phosphate, and sodium chlorite.

3. The method of claim 2, wherein the oxidizing solution includes the oxidizing agent in a concentration that ranges from 2 to 60 grams per liter of the oxidizing solution.

4. The method of claim 1, further comprising roughening the first surface of the first copper foil before wet-oxidizing the first copper foil.

5. The method of claim 4, wherein the first copper foil is roughened in a roughening solution including hydrogen peroxide, sulfuric acid, and a stabilizer.

6. The method of claim 5, wherein the roughening solution includes sulfuric acid in a concentration that ranges from 100 to 250 grams per liter of the roughening solution.

7. The method of claim 6, wherein the roughening solution includes hydrogen peroxide in a concentration that ranges from 20 to 40 grams per liter of the roughening solution.

8. The method of claim 7, wherein the roughening solution includes the stabilizer in a concentration that ranges from 0.5 to 15 grams per liter of the roughening solution.

9. The method of claim 8, wherein the stabilizer is one selected from the group consisting of ethylamine and acetamide.

10. The method of claim 1, further comprising providing a protective layer on a second surface of the first copper foil, which is opposite to the first surface of the first copper foil, before wet-oxidizing the first copper foil such that the second surface of the first copper foil is not oxidized during wet-oxidizing the first copper foil.

11. The method of claim 10, wherein the protective layer is a tape attached to the second surface of the first copper foil.

12. The method of claim 10, further comprising forming an oxygen-isolation layer on a surface of the copper oxide layer of the first copper foil before contacting the copper oxide layer with the first surface of the ceramic substrate.

13. The method of claim 12, wherein the copper oxide layer of the first copper foil is disposed in an anti-oxidizing solution including an antioxidant for forming the oxygen-isolation layer.

14. The method of claim 13, wherein the antioxidant is made from a material selected from the group consisting of benzotriazole, triazole, imidazole, and tetrazole.

15. The method of claim 10, further comprising:
wet-oxidizing a second copper foil such that a first surface of the second copper foil is oxidized to a copper oxide layer, and a second surface of the second copper foil, which is opposite to the first surface of the second copper foil, is not oxidized;
contacting the copper oxide layer of the second copper foil with a second surface of the ceramic substrate, which is opposite to the first surface of the ceramic substrate, before bonding the copper oxide layer of the first copper foil to the first surface of the ceramic substrate; and
bonding the copper oxide layer of the second copper foil to the second surface of the ceramic substrate simultaneously with the bonding of the copper oxide layer of the first copper foil to the first surface of the ceramic substrate by heat treatment.

16. A ceramic-copper foil bonding method comprising:
providing first and second copper foils, each of which has a first surface and a second surface that is opposite to the first surface;
wet-oxidizing the first and second copper foils such that the first surface of each of the first and second copper foils is oxidized to a copper oxide layer, and the second surface of each of the first and second copper foils is not oxidized;
contacting the copper oxide layers of the first and second copper foils with opposite first and second surfaces of a ceramic substrate, respectively; and
heating the first copper foil, the second copper foil, and the ceramic substrate together, thereby bonding the same together.
